(19) United States
(12) Patent Application Publication
(10) Pub. No.: US 2006/0012524 A1
(43) Pub. Date: Jan. 19, 2006

(54) Low-height dual or multi-band antenna, in particular for motor vehicles

(75) Inventors: Frank Mierke, Rosenheim (DE); Peter Karl Prassmayer, Grosskarolinenfeld (DE)

Correspondence Address: NIXON & VANDERHYE, PC, 901 NORTH GLEBE ROAD, 11TH FLOOR, ARLINGTON, VA, 22203, US

(73) Assignee: Kathrein-Werke KG, Rosenheim (DE)

(21) Appl. No.: 10/521,094

(22) PCT Filed: Jun. 12, 2003
(86) PCT No.: PCT/EP03/06199

§ 371 Date: Jul. 13, 2005

(30) Foreign Application Priority Data
Jul. 15, 2002 (DE) 102 31 961.8

(51) Int. Cl. H01Q 1/38; H01Q 1/32

(52) U.S. Cl. 343/700 MS; 343/713

(57) ABSTRACT

The invention relates to an improved, low-height dual or multi-band antenna comprising surface transmitters, whose size varies in accordance with the frequency band to be transmitted. Said antenna is configured from a smaller surface transmitter that is located on top of a larger surface transmitter. The antenna is characterised by the following improved features: the dual or multi-band antenna is essentially configured as a one-piece punched and bent metal part; as a one-piece component, said antenna consists of at least two surface transmitters, which are electrically connected via a short-circuit; and at least the lowest surface transmitter for transmission in a lower frequency band and/or at least a surface transmitters that is lower than the surface transmitter for transmission in the highest frequency band have transmitter wings lying adjacent to their transmitter surface. When the antenna is viewed from above, the respective surface transmitter for transmission in a higher frequency band lies between the wings of said lower frequency band transmitters.

The invention relates to a low-height, dual or multiband antenna, in particular for motor vehicles, as claimed in the precharacterizing clause of claim 1.

The 900 MHz or the so-called 1800 MHz band is used for communication purposes, particularly in German and European mobile radio networks. The so-called 1900 MHz band is used for transmission, particularly in the USA. UMTS networks, which will be the next to appear, are designed to use the 2000 and 2100 MHz band ranges.

Low-height antennas are desirable in particular in the motor vehicle field and are intended to have electrical characteristics which are as good as possible, that is to say in particular a wide bandwidth, a good omnidirectional characteristic and a compact physical form.

Dual-band flat antennas have already been proposed on this basis and are also referred to, inter alia, as “stacked dual-frequency-microstripe” PIF antennas.

One such antenna which is known from the prior art has a flat antenna element which is parallel to a metallic base surface or base plate and is short-circuited on one of its longitudinal faces to the metallic base plate by means of a short circuit which runs at right angles to the flat antenna element and to the base plate. The length and width, and the size, of the flat antenna element are, by way of example, matched to the lowest frequency to be transmitted, for example to the 900 MHz band.

A flat antenna element based on a comparable principle is constructed on this basis, which is intended for transmission of a wider frequency band range, and is correspondingly physically smaller. It is seated with its longitudinal and transverse extent, which are shorter overall, with a further flat antenna element approximately centrally, in a plan view, on the physically larger flat antenna element located underneath it, to be precise likewise in a position parallel to it. On one of its longitudinal faces, preferably on the same longitudinal face as the flat antenna element for the lowest frequency band range, it is connected via a short circuit to the flat antenna element located underneath it. The short-circuiting element is preferably likewise once again aligned at right angles to the two flat antenna elements.

The feed is provided via a feed line which preferably runs at right angles to the flat antenna elements and is routed such that it runs essentially at right angles upward as far as the lower face of the topmost flat antenna element from a feed point, for example a matching network, in the area of the base plate, from which the feed point is isolated. For this purpose, an appropriate passage opening is provided in the flat antenna element located underneath it, in order to route the feed line as far as the topmost flat antenna element.

Although antennas such as these have in fact been proven in practice, the object of the present invention is to provide an improved flat antenna element whose production and assembly are considerably simpler than those for previous solutions. According to the invention, the object is achieved by the features specified in claim 1. Advantageous refinements of the invention are specified in the dependent claims.

The low-height dual or multiband antenna according to the invention is distinguished by its major parts being formed from a complete, integral stamped and bent part.

In other words, at least two flat antenna elements for transmission in two frequency bands as well as a short circuit which acts between them are produced and formed from a single stamped sheet-metal part.

In one preferred development of the invention, the corresponding short circuit for connection of the flat antenna element which is intended for the lowest frequency band range (that is to say that flat antenna element which is provided adjacent to the metallic base plate) is also a component of the entire integral stamped and bent part, that is to say it is a common component with the integral flat antenna.

A further preferred embodiment even provides for the feed line, which runs essentially at right angles to the flat antenna elements, likewise to be in the form of a stamped and bent part, to be precise as a part of the entire stamped and bent part.

The entire design can be cascaded a number of times, so that not only two but also at least three flat antenna elements are formed, which are of different sizes, are each arranged one above the other and run essentially parallel to one another, in order that the compact antenna can also transmit and receive, for example, as a multiband antenna in three band ranges.

Finally, it has also been shown that the dual or multiband antenna may have flat antenna elements which are not necessarily in each case formed at different heights to one another but at the same height, with the short circuit between two flat antenna elements in this case then likewise being arranged such that it runs at the same height level.

The flat antenna elements can essentially be provided with parallel and vertical cut edges and bending edges in a plan view. However, it is just as possible for the stamped edges, which in each case point outwards, of the higher flat elements for transmission in the higher frequency band range to be designed, for example, such that they run diverging slightly outwards from their short-circuit links toward their free end, or such that they converge inward, or to have obliquely running end edge areas in particular at their free end. The stamped edges of the lower-level flat elements can likewise be designed such that they run obliquely, in which case the stamped edges on the outside and inside need not necessarily run parallel.

Another preferred development of the invention furthermore makes it possible to provide for the antenna vanes to be lengthened downwards by a further bend.

In addition, the short-circuit connections need not be formed over the entire width of the respective flat element, but may be shorter than the adjacent transverse extent of the respective flat element.

The invention will be explained in more detail in the following text with reference to drawings in which, in detail:

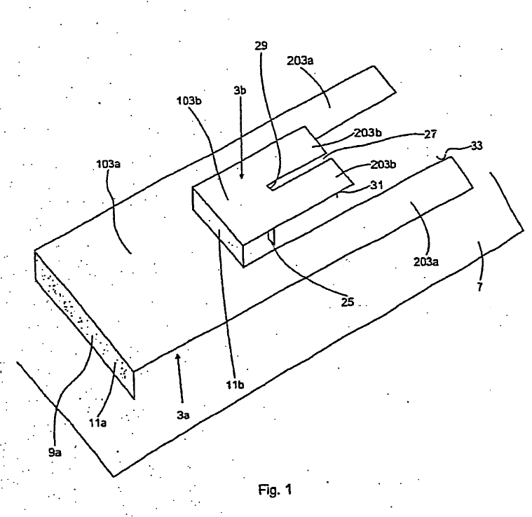

FIG. 1: shows a first perspective view of a first dual-band antenna;

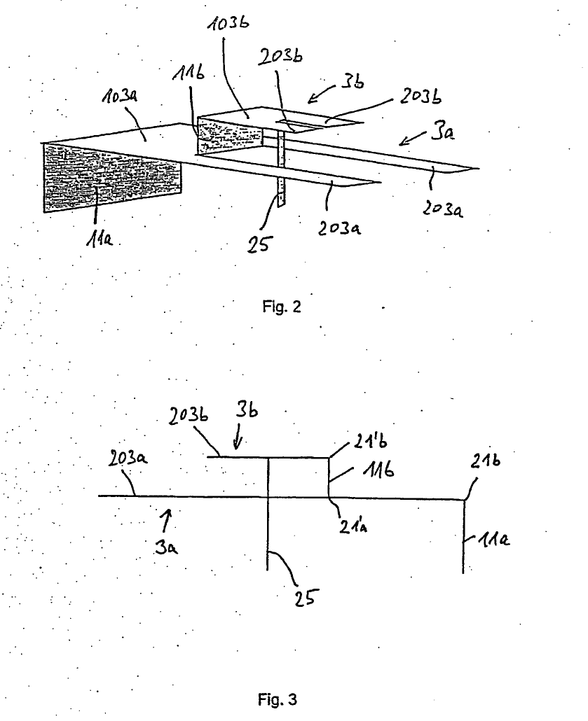

FIG. 2: shows another perspective illustration of the dual-band antenna illustrated in FIG. 1;

FIG. 3: shows a corresponding rearward side view of the flat antenna illustrated in FIGS. 1 and 2;

FIG. 4: shows a corresponding plan view of the flat antenna shown in FIGS. 1 to 3;

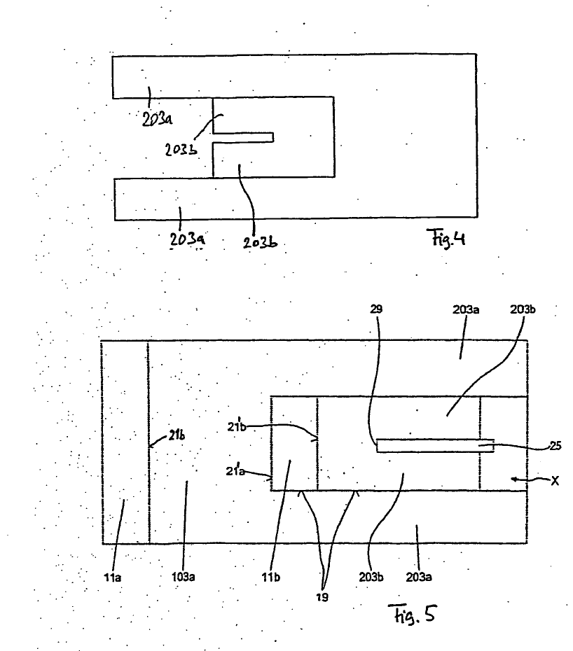

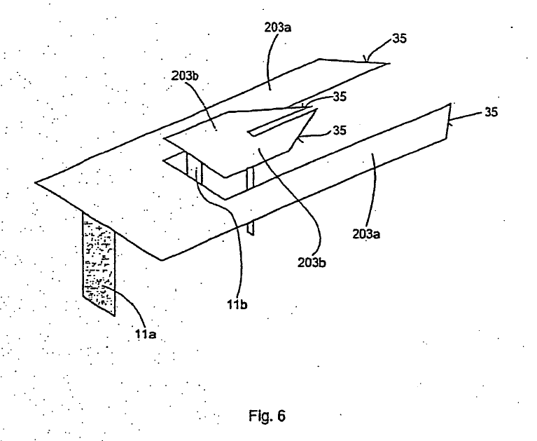

FIG. 5: shows a plan view of a metallic blank plate (metal sheet) on which the stamping and bending lines for production of an antenna in FIGS. 1 to 4 are shown;

FIG. 6: shows an exemplary embodiment of a corresponding flat antenna, modified from that shown in FIG. 1;

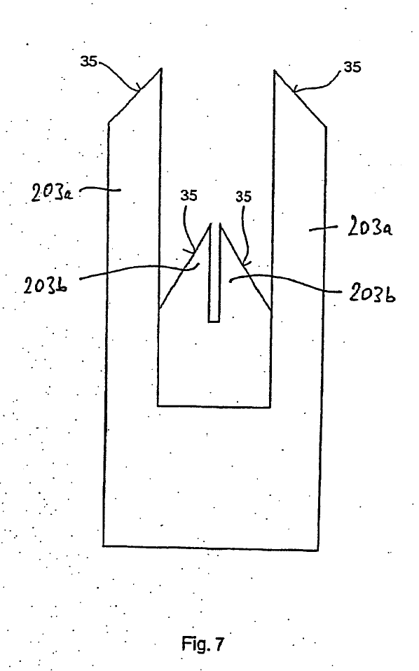

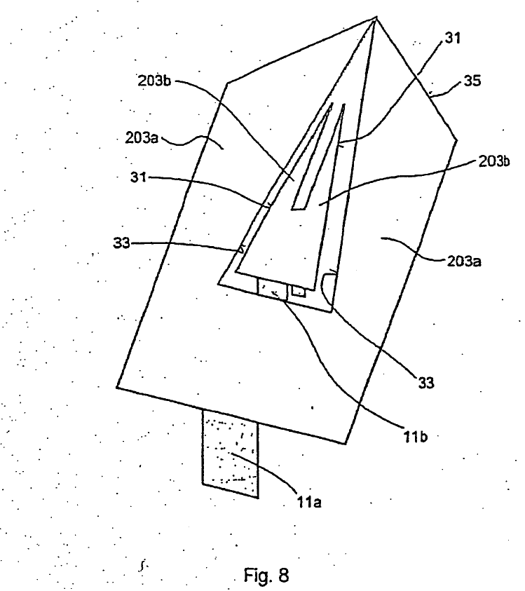

FIG. 7: shows a plan view of the exemplary embodiment shown in FIG. 6;

FIG. 8: shows a perspective illustration of another modified exemplary embodiment of a flat antenna;

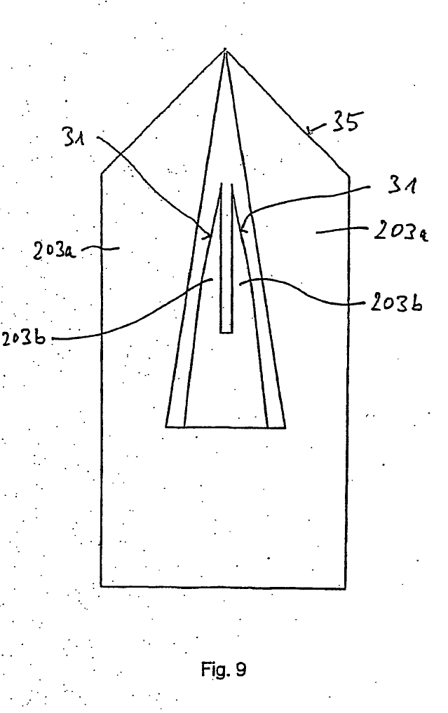

FIG. 9: shows a plan view of the illustration shown in FIG. 8;

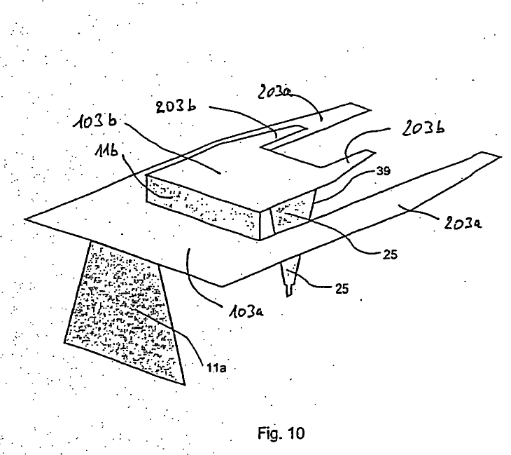

FIG. 10: shows a perspective illustration of another modified exemplary embodiment;

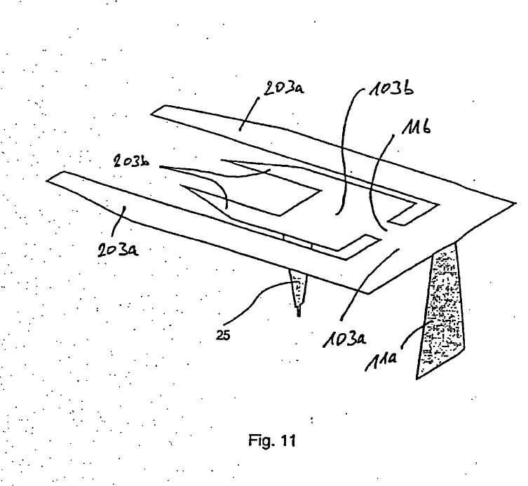

FIG. 11: shows a further exemplary embodiment of a dual-band antenna with antenna surfaces at the same height;

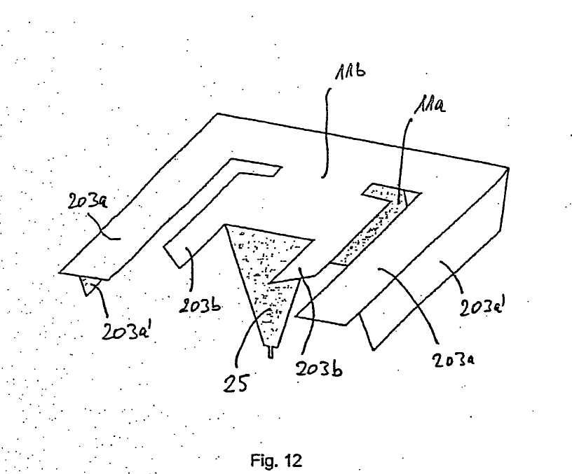

FIG. 12: shows a perspective illustration of a further exemplary embodiment with antenna vanes which have been lengthened downwards;

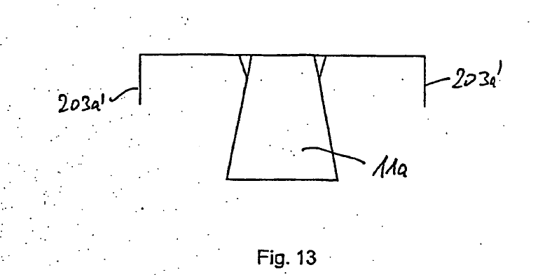

FIG. 13: shows a rearward side view of the illustration shown in FIG. 12;

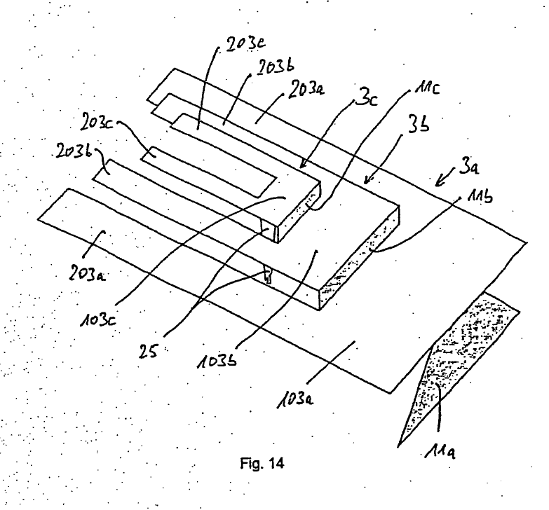

FIG. 14: shows a perspective illustration of a further exemplary embodiment of a triband antenna; and

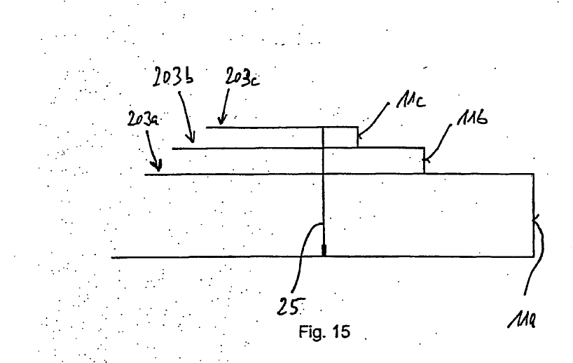

FIG. 15: shows a side view of the exemplary embodiment shown in FIG. 14.

FIGS. 1 to 4 show a first exemplary embodiment of a low-height compact dual-band antenna according to the invention, which comprises two flat antenna elements 3a and 3b which are arranged parallel to one another. An antenna element such as this is normally provided with a larger metallic surface or base plate 7, that is to say it is connected to it, or a corresponding antenna is, for example, when used on a motor vehicle, fitted at an appropriate point on the sheet-metal bodywork of the vehicle, which is then used as the metallic opposing surface or base surface.

The lower flat element or the lower flat antenna element 3a is tuned for transmission in a lower or low frequency band, for example in the 900 MHz band range. The physically smaller flat antenna element 3b which is constructed above this is, for example, tuned for transmission in the region of the 1800 MHz band range.

The upper flat antenna element 3b is connected on its narrower boundary face or edge 9b, which is located on the left in FIG. 1, via a short circuit 11b to the physically larger flat antenna element 3a located underneath it, with the short circuit 11b in the illustrated exemplary embodiment having a width which corresponds to the width of the upper flat antenna element 3b.

The lower flat antenna element 3a is likewise equipped on its narrower boundary face 9a, which is located on the left, with a vertical short-circuiting surface 11a, via which an electrical connection is normally produced to the electrical base surface or base plate 7 that has been mentioned.

Finally, the upper and the lower flat antenna elements are each equipped such that a part of the respective flat antenna element comprises a closed metal surface section 130a or 130b, to which two antenna vanes 203a and 203b, respectively, which are offset in the transverse direction of the antenna element, are then connected on the respective opposite face to the short circuit 11a or 11b.

In the illustrated exemplary embodiment, the entire antenna that is shown in FIG. 1 is produced from a single stamped and bent part, with the exception of the base plate 7. In this context, FIG. 5 shows a metallic blank metal sheet in which the corresponding stamping lines 19 are shown by dashed-dotted lines, with the bending edge 20 being shown by a dotted line. The flat antenna element 3b for the respective higher frequency band range can then be positioned higher than and parallel to the flat antenna element 3a located underneath it by means of the stamping and cutting process and by subsequently bending along the bending edges 21′a and 21′b, as can be seen from FIGS. 3a and 3b. The bending process in this case results in the short circuits 11a and 11b being positioned at right angles to the plane of the flat antenna elements.

The plan view of the blank sheet-metal part shown in FIG. 5 in this case shows that, in this exemplary embodiment, only the material area identified by x need be cut out and removed during the stamping process. The remaining parts are just stamped and/or folded and bent on the corresponding lines in order then to produce the dual-band antenna illustrated in FIGS. 1 to 4.

Finally, a feed line 25 is also required, which is preferably provided at right angles to the plane of the flat antenna elements and is routed from underneath up to the lower face of the flat antenna element 3b above it. In the illustrated exemplary embodiment, this feed line 25 is likewise produced as a stamped and bent part, for which purpose the uppermost flat antenna element 3b has a recess 27 in the form of a slot, to be precise extending from a bending edge 29 which is formed at the left of the end of the recess 27 which is in the form of a slot, thus making it possible to bend a narrow metal strip at right angles downward in order to form the feed line 25 that has been mentioned.

In the exemplary embodiment shown in FIGS. 1 to 4, the blank material, which is in the form of a plate, is thus used virtually completely, since the flat antenna element which is located between the outer side edges 31 of the upper flat antenna element 3b and the inner side edges 33 of the flat antenna element located underneath it is formed just by means of a stamping or cutting line 19 without having to cut out the material. In the exemplary embodiment shown in FIGS. 6 and 7, in contrast, a respective short circuit 11a or 11b is made narrower in the transverse direction of the flat antenna elements, so that corresponding material areas have to be stamped out of a blank metal plate while carrying out the stamping and bending process.

Furthermore, the front ends of the antenna vanes 203a and 203b are not provided at their free end with end or cut edges 35 which run at right angles to the longitudinal extent of the antenna vanes, but with end or cut edges 35 which run toward one another obliquely from the outside inward, that is to say they converge.

In the exemplary embodiment shown in FIGS. 8 and 9, the outer cut edges 31 of the respective higher flat antenna element converge from the short-circuit face toward the free end, and in this case are parallel to the correspondingly converging inner cut edges 33 of the lower flat antenna element 3a. This results in antenna vanes 203b which run to a point, at least for the higher flat antenna element 3b. The antenna vanes 203a of the lower flat antenna element have a width and extent which increase towards their free end. The outer end or cut edge can likewise be designed such that it converges again, in which case the front end tips of the antenna vanes 203a of the lower flat antenna element can then touch one another, or virtually touch one another.

In the exemplary embodiment shown in FIG. 10, the piece of feed line, which is likewise produced as a stamped or bent part, is likewise formed from the top downwards as an increasingly narrower metal strip, that is to say as a metal strip with stamped edges 39 which run toward one another, converge and are on opposite sides. Conversely, the short circuit 11a has a trapezoidal shape running from the bottom upwards, at least with respect to the flat antenna element for the lower frequency band range. Finally, the exemplary embodiment illustrated in FIG. 11 shows that the antenna surfaces as well as the antenna vanes for the various frequency band ranges may also be arranged at the same height level, that is to say arranged in an O-shape or in the form of a fork, so that, in this exemplary embodiment as well, the short circuit 11b which connects the two flat antenna elements 11b and 11a is located in an arrangement at the same height.

A multiband antenna can also be designed in a corresponding manner to the explained exemplary embodiment, specifically by adding a third flat antenna element, for example, to the corresponding cascading of the two flat antenna elements as explained in the drawings, which third flat antenna element is physically smaller and is formed in a corresponding repetitive manner on the second flat antenna element. In this case as well, the complete antenna formed in this way may be produced as a single stamped and bent part, that is to say it may be integral.

The following text refers to the exemplary embodiment shown in FIGS. 12 and 13. In this exemplary embodiment, the antenna element vanes 203a of the lowermost flat antenna element are provided with antenna vane sections 203a′ which have been lengthened downwards, thus resulting in the advantage that the antenna vanes 203a can be shortened overall in comparison to other exemplary embodiments and, at the same time, are mechanically more robust. In the illustrated exemplary embodiment, the corresponding antenna vane sections 203a′ are in this case formed with bent metal sections, which project vertically downward, on the outer edge of the antenna vanes.

If specified appropriately, antenna vane sections such as these may also alternatively or additionally be provided on an antenna vane 203b on a flat antenna element 3b for transmission in a higher frequency band.

FIGS. 14 and 15 illustrate a corresponding antenna type, which is suitable for transmission and reception in three bands which are offset with respect to one another. The corresponding design of the flat antenna element 3b in this exemplary embodiment is effectively cascaded once again, in comparison to the previous exemplary embodiments, by the addition of a physically smaller flat antenna element 3c located above it, which likewise once again has corresponding antenna element vanes 303a. The connection to the antenna element 3b located underneath it is likewise made via a corresponding short circuit 11c. The feed is provided via a feed line 25, which leads to the uppermost flat antenna element 3c.

The antennas which have been explained are so-called PIF antennas, that is to say so-called “planar inverted F antennas”. In this case, it is known that the characteristics of the respective antenna can be influenced in the case of antennas such as these by the configuration and the location of the feed point and of the short circuits. The characteristics of the antennas can thus be individually matched to the influences of the respective vehicle bodywork and the respective installation location by the configuration and the location of the feed point and of the short circuits. In this case, the short circuits, for example the short circuits 11a and 11b, are generally each located on the narrow face of the antenna arrangement, which is preferably basically longitudinally symmetrical (that is to say symmetrical with respect to a vertical central longitudinal plane). The feed point for the antenna is preferably provided on this longitudinal line of symmetry or longitudinal plane of symmetry of the antenna. The antenna impedance, which should normally be 50 Ohms for car radio antennas, can also be matched by the position of the feed point and its distance from the short circuit.

1. A low-height dual or multiband antenna comprising:
a) the dual or multiband antenna is arranged or can be positioned on a metallic base surface or base plate,
b) the dual or multiband antenna has at least two flat antenna elements for operation in two frequency bands which are offset with respect to one another,
c) the two flat antenna elements are aligned parallel, or at least approximately parallel, to one another,
d) the size of the at least two flat antenna elements decreases from that flat antenna element which is closest to the base surface to that flat antenna element which is furthest away from the base surface or base plate,
e) the flat antenna element is in each case connected to the flat antenna element for transmission in a higher frequency band range, and the flat antenna element is intended for transmission in a frequency band range which is lower than this,
f) the flat antenna elements have a short circuit on one face, such that one flat antenna element for transmission in a higher frequency band is short-circuited via the short circuit to the flat antenna element for transmission in a lower frequency band than this, and the flat antenna element for transmission in the lowest frequency band range is connected or can be connected via a short circuit (ha) to the metallic base surface or base plate,
including the following further features:
g) the dual or multiband antenna is in the form of an integral stamped and bent metal part,
h) the antenna has, as an integral component, at least two flat antenna elements and the short circuit which is provided between two flat antenna elements,
i) at least the flat antenna element for transmission in the lowest frequency band and/or for transmission in a frequency band which is lower than an upper frequency band has or have adjacent to its or their antenna element surface antenna element vanes which are electrically connected to the associated antenna element surfaces, with the respective flat antenna element for transmission in a frequency band higher than this coming to rest between these antenna element vanes in a plan view of the antenna,
j) the flat antenna element for transmission in a higher frequency band is arranged on the same plane as the flat antenna elements for transmission in a frequency band lower than this, or is arranged with a lateral offset with respect to it on a plane which runs parallel or at least approximately parallel to it, and
k) a feed line which runs from underneath to the lower face of the flat antenna element arranged at the top is likewise in the form of a stamped and bent part, which is integrally connected to the remaining parts of the antenna formed in this way.

2. The antenna as claimed in claim 1, wherein the electrical short circuit (jib) which connects the adjacent flat antenna elements is connected to the two flat antenna elements via two bending edges in opposite senses.

3. The antenna as claimed in claim 1, wherein the flat antenna element which is arranged at the bottom is provided with a short circuit (ha) which forms a part of the antenna and is connected via a bending line to the antenna element surfaces of the flat antenna element.

4. The antenna as claimed in claim 1, wherein a recess which is in the form of a slot is incorporated in the flat antenna element arranged at the top, to be precise forming a feed line, which is curved downward over a bending line, essentially at right angles to the plane of the flat antenna element.

5. The antenna as claimed in claim 1, wherein the end edges of the antenna vanes run at right angles to the longitudinal edges of the antenna vane.

6. The antenna as claimed in claim 1, wherein the end edges of the antenna vanes are aligned such that they converge from the outer edges toward the center or diverge outwards from the outer edges.

7. The antenna as claimed in claim 1, wherein those side edges which point outward of the antenna vanes (203b) of the antenna elements for higher frequencies run from their face which is provided with a short circuit such that they converge toward their free end or diverge outwards.

8. The antenna as claimed in claim 1, wherein those stamped edges which point inward of the antenna vanes of the antenna elements which are provided for the lower transmission ranges run from their short-circuit face such that they converge toward their free end or diverge outward.

9. The antenna as claimed in claim 1, wherein the short circuits have a rectangular shape and preferably extend over the entire width of the associated antenna element.

10. The antenna as claimed in claim 1, wherein the short circuits are shorter than the width of the antenna elements.

11. The antenna as claimed in claim 10, wherein the short circuits have a triangular or trapezoidal shape.

12. The antenna as claimed in claim 1, wherein the antenna vanes of the flat antenna elements are arranged at different height levels, with in each case one flat antenna element for transmission in a higher frequency band range being arranged above one for transmission in a frequency band range which is lower than this.

13. The antenna as claimed in claim 1, wherein at least two flat antenna elements are arranged with their antenna vanes at the same height level.

14. The antenna as claimed in claim 1, wherein the antenna element vanes are preferably provided on their boundary edge which points outward with antenna vane sections which are preferably aligned such that they point downward.

15. The antenna as claimed in claim 1, wherein the antenna is in the form of a triband antenna and, cascaded with respect to it, has a third flat antenna element which has at least a similar shape to that of the other two flat antenna elements and is matched for transmission in the highest frequency band range.
